(19) United States
(12) Patent Application Publication
(10) Pub. No.: US 2010/0129191 A1
(43) Pub. Date: May 27, 2010

(54) Method and Device for Handling of Fish

(76) Inventor: Asbjørn Ingemar Larsen, Alsvag (NO)

Correspondence Address: CARELLA, BYRNE, CECCHI, OLSTEIN, BRODY & AGNELLO, 5 BECKER FARM ROAD, ROSELAND, NJ, 07068, US

(21) Appl. No.: 12/451,234

(22) PCT Filed: Mar. 28, 2008
(86) PCT No.: PCT/NO2008/000118

§ 371 Date: Oct. 30, 2009

(30) Foreign Application Priority Data
Mar. 30, 2007 (NO) 20071695

(51) Int. Cl. A01K 79/00; B63B 35/14; B63B 35/24

(52) U.S. Cl. 414/806; 114/255; 43/4.5

(57) ABSTRACT

A method for handling fish (42) which are pulled, or fall, off a fishing line (10) when it is hauled on board a fishing boat, is disclosed. The method is characterized in that the fish are forced to drop into a water-filled well (11) inside the vessel, and the water in the well (11), and in that the fish, is forced to flow in the direction towards the transport section (3,4) in conjunction with the well (11), from where fish are transported to further treatment. A device for the implementation of the method is also disclosed.

The present invention relates to a method of handling fish as given in preamble of the following claim 1, which fish are pulled off from a line when hauling said line, wherein fish are transferred further for additional treatment, such as to a bleeding bin.

More precisely the invention relates to operation of a fishing line on board a fishing vessel for handling fish that are de-hooked (and released) when the line is hauled.

The invention also relates to a device system defined in the preamble of claim 8.

A fishing line consists of a main line to which a given number of gangions or snoods are attached at regular intervals along the main line. A fishing hook is attached to the free end of each of the snoods. The present invention relates to operation of an automatic line hauler integrated in a vessel, the line hauler being used to haul the line on board the vessel.

When the line is hauled on board the vessel by means of the line hauling machine (i.e. a line winch), the main line with the catch of fish is hauled via a device for de-hooking, wherein the fish are released from the hooks, and further the fish are transported in an automatic manner upwards to a production deck and a bleeding bin without any need for a crew to operate a gaff, in that this operator is normally denoted being a gaffer. The gaff is used in traditional long-lining for de-hooking and securing catch of fish.

The work of a gaffer to secure the catch as fish are de-hooked is perceived as exposed and labour intensive work on board a fishing vessel operating long-lines. The work is monotone and the gaffer is exposed to wind and sea spray and he/she risks health problems with arms and shoulders so that long term injuries may often occur. The work is therefore characterized as being very intensive during a full fishing period, usually lasting for periods of several weeks.

Fish with injuries and wounds and a corresponding reduced quality from gaffing is a problem for the land based fillet production because parts of the fish muscles must be removed by use of a cutting instrument (a knife). This operation represents an economical loss due to reduced utilization of the raw material. Additionally, more labour is needed in order to remove bloodstains from the fillets caused by the gaff.

Incidentally the attention is directed to previous state of art known systems for automatic de-hooking. In particular reference is made to the Norwegian Patent application No. 1979 0472, U.S. Pat. No. 1,777,783, as well as Norwegian patents NO-146.303 and NO-157.153.

Several and different solutions to these problems are also disclosed in the Norwegian patent application No. 20034675 belonging to the Applicant of the present application. On a rail or gunwale of the vessel, there is a system installed to de-hook fish and let them fall into a sea-filled well, i.e. outside of the ship's side of vessel itself. The flow of water (i.e. sea water) created during the hauling process, for example due to the forward movement of the vessel, moves the fish into a collection chamber and an inclining conveyor brings the fish up to the production deck for further treatment on board the vessel.

The disadvantage with this system is its installation along the rail (gunwale) on the outside of the vessel. Another disadvantage is that its function is based on a relative motion between sea and vessel to lead fish into said collection chamber.

It is an object of the present invention to mainly eliminate the disadvantages with the abovementioned earlier known methods for treatment of fish caught by long-lines.

It is another object of the present invention to find and establish a new method and a system for handling fish which are de-hooked from a line to bring them automatically to the transport system which moves them out of the collection chamber for further treatment, such as to a bleeding bin (bleeding station).

Further, another object of the invention to find a new solution to handle a catch onboard the vessel without having to employ a gaffer operator as mentioned above.

Further goals of the present invention are listed below, representing:
Achieving improved working conditions and environment on board fishing vessels.
Integrating the whole system inside of the vessel.
Avoiding quality reducing damages on fish during treatment.
Achieving fish catches exhibiting better quality as a result of the improved handling of the present invention.
Improving economy, because number of operators of the crew can be reduced.
Giving sea and land based production plants better outcome as a result of improved fish quality.
Being able to close the normal hauling hatch into the hauler room during extreme weather to protect the crew at the bleeding station from and direct exposure to wind and sea spray.

According to the present invention, the method is characterized by that the fish are forced to fall into a water-filled well inside the vessel, and that the water in the well, and with it the fish, is forced to flow in a direction towards a transport section connected to the well, from where fish are transported for further treatment.

According to a preferred embodiment the water flow is generated by a mechanism pumping water into a water reservoir in the well so that fish are transferred to the transport section.

According to a another preferred embodiment the sea water is pumped on board through a pipe system and pumped to the nozzles which creates the flow in the water reservoir of the well.

According to a further preferred embodiment the water fluid flow is created by forcing water, such as by pumping, back to the ocean through a pipe, and the outlet from the well to the pipe is comprised by a grid/grating preventing loss of fish.

According to a further preferred embodiment the flow is created by a propeller system installed in the lower part of the well.

According to a further preferred embodiment the flow is created as the water in the well is set in aforesaid flow by internal pumping of the water in the well, or by recycling through a pump/nozzle system (injector) or by operation of a propeller system.

According to a further preferred embodiment the fish are transported by an endless (interminable) conveyor belt comprising carriers capturing the fish from the water in the well.

The device for implementing method according to the present invention is characterised in that
a well of a fishing vessel arranged to be filled with water wherein de-hooked fish are forced to fall,
means for creating a water flow in the well, and
a transport section for bringing bring fish out of the well.

According to a preferred embodiment the flow-creating means comprises a nozzle-system is arranged to inject water into the well or to recycle water in the well.

According to a further preferred embodiment a pipe system is operable to supply water (sea water) to the pump/nozzle system.

According to a further preferred embodiment the flow-creating means comprises a pipe system including a thruster, to conduct a surplus water from the well back to the ocean, comprising a pump.

According to a further preferred embodiment the flow-creating means comprise a given number of propellers inside a discharge pipe from the well, or the well forming sections of the vessel.

According to a further preferred embodiment the endless/interminable conveyor belt comprises carriers arranged for said catch of fish.

According to the invention, that fish being brought on board for de-hooking will fall into a water filled reservoir inside the vessel and than by a man-made water flow brought to the (transportation) device which transports the fish for further treatment.

The main difference between the present invention and previous known state of art technique, is that fish are de-hooked from the line inside the vessel and close to a water filled reservoir, compared to and in contrast to being de-hooked and falling into a water filled chamber on the outside of the vessel.

Despite being referred to an endless conveyor, other methods for bringing fish from the well (collection chamber) and into the bleeding station may be employed, such as by operating a fish pump.

Inside the chamber, a water flow, including the de-hooked fish, is created through the collection well, water is forced by the flow towards the conveyor belt. Fish will then be picked up by the conveyor belt and brought up the production deck and it will drop into, for instance, the bleeding bin, right below the conveyor. Fish are subsequently treated according to production plans and familiar ways of fish production.

In a similar manner as with the previously known solution from the applicant, the crew are able to concentrate more on catch treatment, such as bleeding, gutting, washing and storing of the fish, to achieve best possible fish quality.

The invention is to be further explained with reference to following drawing figures, in which:

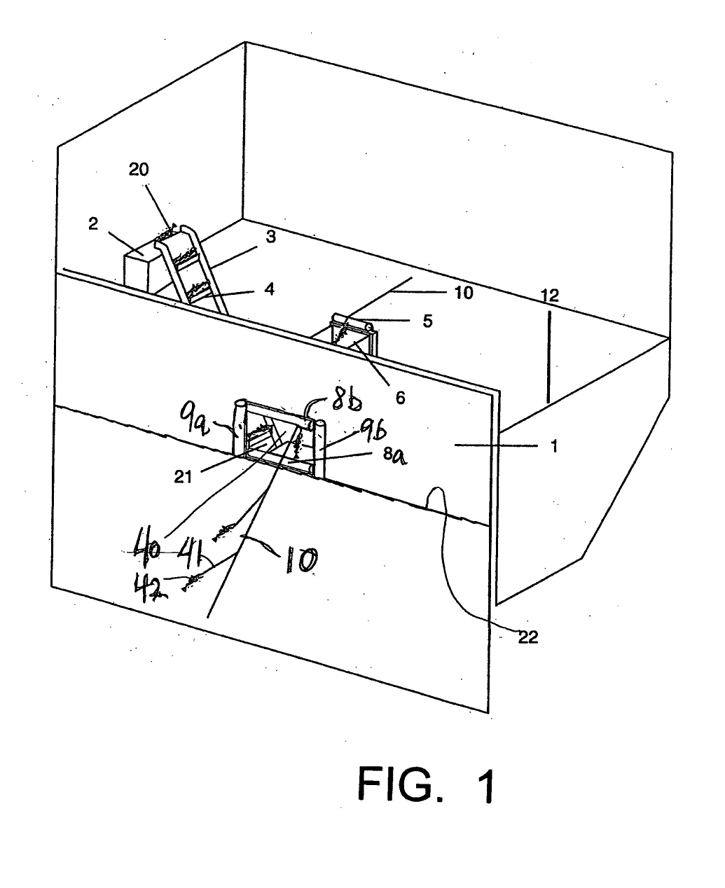

FIG. 1 shows a principle drawing and an expanded perspective of parts of a fishing vessel with the invented device wherein fish drop into a water reservoir inside the vessel.

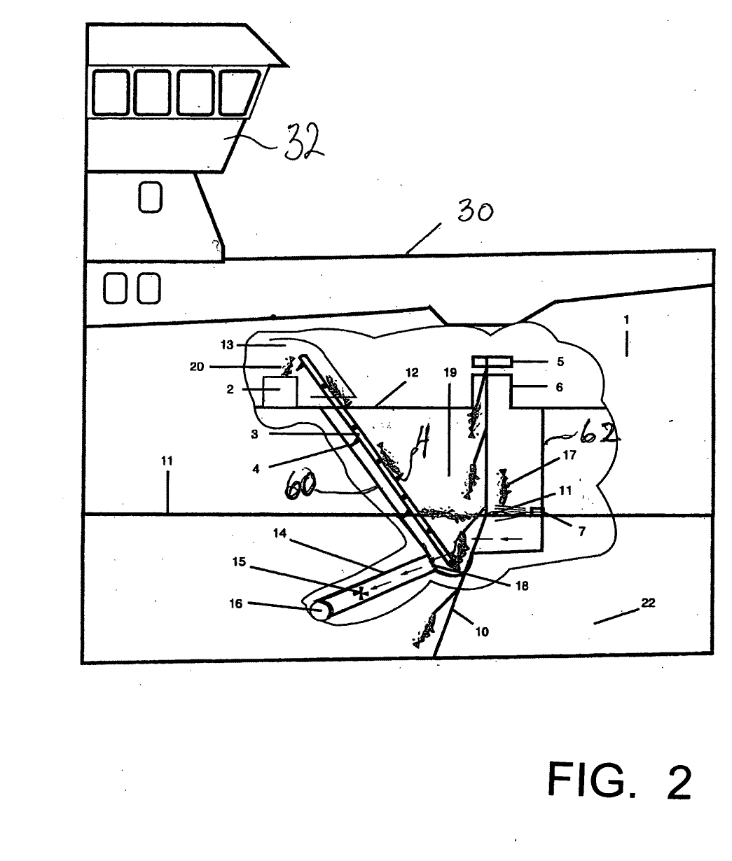

FIG. 2 shows a principle drawing of the cross-section with details of the invention.

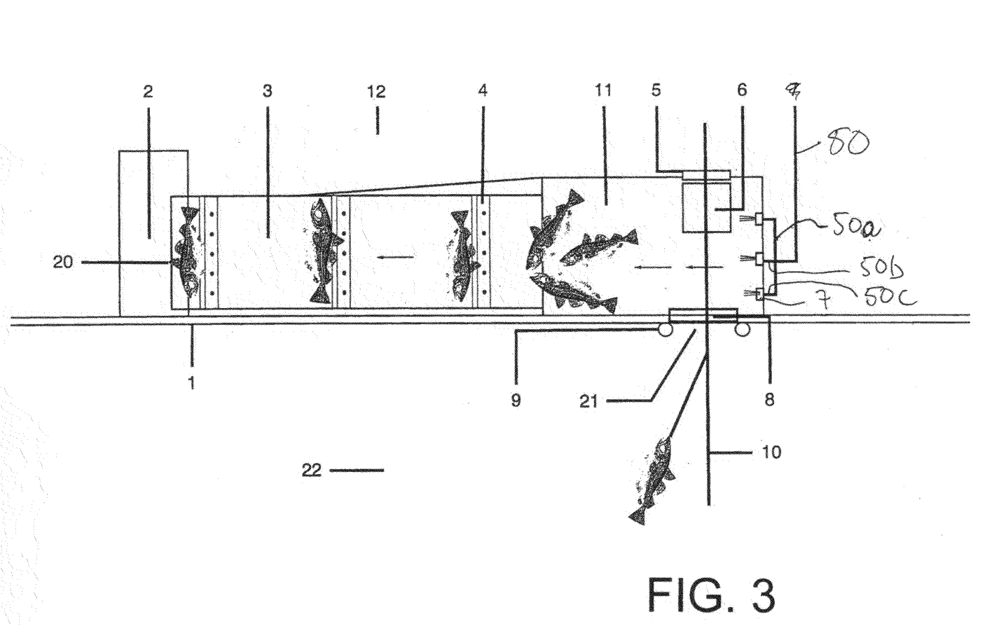

FIG. 3 shows a principle drawing of an embodiment of the invention seen from above.

In the following, reference is made to the accompanying drawing figures wherein a side of a vessel is shown at 1, and a waterline is shown at 22. The drawing FIG. 2 shows parts of a hull structure of the vessel and an upper deck at 30 and the superstructure 32 including a wheel house of the vessel. In the ship's side of the vessel there is a hatch 21/40, i.e. an opening which can be opened and closed. The hatch comprises and is framed by horizontal 8a, 8b and the vertical 9a,9b (preferable elongate) pulleys or roller elements. The line 10 is a normal fishing long-line with snoods/gangions 41 and hooks. The line 10 with a fish 42 hooked in an end of a snood/gangion is hauled on board the vessel through the hatch opening 40.

On the inside of the opening 40 in the vessel's side there is an open well 11 arranged from wall sections and a bottom section of the vessel. As shown in FIG. 2, a sloping wall 60 defines an aft wall section of the well, whilst a vertical wall 62 defines an opposite wall. The well 11 is filled with water to handle a catch of fish.

In one side of the well a lower part of a continuous/endless conveyor belt 3 reaches into the water in the well 11. The conveyor belt is placed angularly (tilted) or vertically and connects to an fish handling station area 2 for further treatment of the fish, such as a bleeding station bin 2.

A given number of carriers, such as transport forks 4, are attached to the conveyor belt 3 and they are shaped as boards, fingers, grids/gratings or similar in order to be able to pick up fish from the water in the well. A power unit (not shown in the figures) drives the conveyor belt and transports the fish out of the water in the bottom of the well 11 and onwards to the top of the conveyor 20 (and its outlet) from where fish are dropping into the bleeding station 2 or bleeding bin. The bleeding station or bleeding bin 2 is located on one of the boats deck 12 connected to the fish production line.

After removing the fish from the line 10, the line 10 is hauled further above over the water filled well 11 and through another opening/chute 6 in the vessel's deck over an elongate horizontal roller 5 for further handling of the line 10.

During hauling of the fishing line 10 some of the fish 42 are de-hooked at a normal crucifier shaped element in front of a line winch. The crucifier represents a narrow slot in an element of the structure, through which slot arrangement the line 10 is conducted, so that the fish are pulled off from the line snood hooks. Other fish 42 are de-hooked as the fishing line 10 pass through the well 11 and they will drop into the water reservoir in the well 11. These fish are moved towards the conveyor belt and picked up by the carriers 4 of the belt.

With reference to FIG. 2, a pipe 14 is arranged from the bottom of the well 11, i.e. from below or under the conveyor belt 3 from the well 11 and out through an outlet 16 in the side of the vessel (beam end), and into the sea. A water penetrable grid/grating 18 prevents fish from escaping through the pipe 14. Thrusters or propeller systems 15 may be arranged inside the discharge pipe 14 to operate to pump or conduct water from the well and out into the sea outside of the vessel. Thus the pipe 14 functions as a discharge pipe or discharge channel from the well.

As shown in FIG. 3, there is in one of the sidewalls of the well a set of nozzles or injectors 7 arranged to inject or spray water into the water filled well 11, in order to create a fluid flow in the well 11.

Preferably a pipe system 50 brings water to a branching point from where branch pipes 50a,50b,50c conduct water into each nozzle 7. A non-visualized pump pumps water, for example sea water, through the pipes 50 and into the nozzles 7. Water quantity and water pressure through the nozzles can be adjusted by the crew of the vessel/boat in order to create a suitable water fluid flow. As an alternative to nozzles with water fed from exterior environment, water can circulate in the well, by ejection only. A propeller system driven by a electric/hydraulic operated drive motor arranged connected to a wall defining the well, can also by used to create such a suitable water fluid flow (or current) in the water in order to conduct the fish to the conveyor belt 3.

To achieve balance (equilibrium), similar quantities of water entering through the nozzles 7 must be pumped out into the sea (outside the boat). Sea water will normally also enter through the hatch 40 through which the fishing line is hauled. An essential feature with the invention is the creation of a water flow inside the well volume in order to guide the fish towards the conveyor belt 3.

The nozzle system 7 and the entrance (inlet) to the conveyor belt 3 are placed in a practical manner, opposite each other. The object of these means for pumping water into the well is to create a water fluid flow to move fish in a gentle manner through the water volume and towards the conveyor belt 3 to enable or allow them to be transported further on. Relative to the longitudinal direction of the vessel, the conveyer belt can be placed posterior, at the leading edge or sideways in the well.

It is an advantage with the invention that fish fall into a water reservoir during de-hooking. In this manner the possibilities for skin- and flesh injuries on fish are reduced.

By injecting water continuously into the well 11, the water inside it is exchanged continuously. Because water injected through the nozzles is fresh water, for example seawater from the outside, the water in the well 11 is kept clean and fresh. Similar water exchange may be achieved from water entering through the hatch 40.

A control valve regulates the operation such as start, speed and stop, of the conveyor belt 3.

Thus, the water fluid flow may be achieved by using the pump/proplelar 15 inside the pipe 14, injecting water through nozzles 7, or having a separate propeller system arranged inside the well.

### SUMMARY OF THE INVENTION

Fish 42 enters the boat with the fishing line 10 via a set of secondary elongate rollers (guiding rollers), they are de-hooked from the fishing line 10 at the primary roller with crucifier and they fall into the water reservoir in the well 11. The fish are then moved by the water flow created by the water nozzles 7 and/or by the thruster (propeller system) 15 in the pipe 14, which leads the water out from the well. The fish are then guided to the conveyor belt 3 with carriers 4, driven by an electrical or hydraulic motor, and it transports fish to the top of the conveyor 20, from where fish falls into the bleeding station 2.

The present invention represents a technological advantage compared to the solution of placing the system on the vessel's or boat's gunwale and outside the vessel.

### DRAWING FIGURES EXPLANATION TO REFERENCE NUMERALS

FIG. 1 showing in perspective an integrated automatic line hauler system (ALH) in a long-line vessel:
1 Ship's side or beam end

2 Bleeding station or bleeding bin
3 Conveyor belt
4 Carrier or carrying fork
5 Roller (primary)
6 Shute
8a,b Elongate roller (secondary)
9a,b Elongate Side roller (vertical)
10 Fishing (main) line
12 Factory or production deck
20 Outlet for fish
21 Hauling hatch
22 Sea water
40 Hatch (at the load line)
41 Snoods/gangions
42 Fish

FIG. 2 is a cross-section of an integrated automatic line hauler system (ALH) in a long-line vessel:
1 Ship's side or beam end
2 Bleeding station or bleeding bin and conveyor belt
3 Conveyor belt
4 Carrier or carrying fork
5 Roller (primary)
6 Shute
7 Sea water nozzles
10 Fishing (main) line
11 Water surface
12 Factory or production deck
13 Cover over conveyor belt
14 Outlet pipe for sea water (flow)
15 Pump/thruster
16 Outlet in the ship's side (beam end)
17 De-hooked fish
18 Grid or grating
19 Hauling well
20 Outlet for fish
22 Sea water
60 Sloping wall
62 Opposite, vertical wall

FIG. 3 showing seen from above an integrated automatic line hauler system (ALH) in a long-line vessel:
1 Ship's side or beam end
2 Bleeding station or bleeding bin and conveyor belt
3 Conveyor belt
4 Carrier or carrying fork
5 Roller (primary)
6 Shute
7 Sea water nozzles
8 Roller (secondary)
9 Side roller (vertical)
10 Fishing (main) line
11 Water surface
12 Factory or production deck
20 Outlet for fish
21 Hauling hatch
22 Sea water
50 Feeding water pipe

1. Method of handling fish (42) falling off a fishing line (10) when said line (10) is hauled on board a fishing vessel, characterised in that the fish (42) are forced to fall into a water filled well (11) inside the vessel, and that the water in the well (11), and with it the fish, is forced to flow in a direction towards a transport section (3,4) connected to the well (11), from where fish are transported for further treatment.

2. Method in accordance with claim 1, characterised in that the water flow is generated by a mechanism pumping water into a water reservoir in the well (11) so fish are transferred to the transport section (3,4).

3. Method in accordance with claim 1, characterised in that sea water is pumped on board through a pipe system and pumped to the nozzles which creates the flow in the water reservoir of the well (11).

4. Method in accordance with claim 3, characterised in that the flow is created by forcing water, such as by pumping (15), back to the ocean through a pipe 14, and the outlet from the well (11) to the pipe (14) is comprised by a grid/grating preventing loss of fish.

5. Method in accordance with claim 1 characterised in that the flow is created by a propeller system installed in the lower part of the well (11).

6. Method in accordance with claim 1, characterised in that the flow is created as the water in the well (11) is set in aforesaid flow by internal pumping of the water in the well, or by recycling through a pump/nozzle system (injector) or by operation of a propeller system.

7. Method in accordance with claim 1 characterised in that the fish are transported by an endless (interminable) conveyor belt (3) comprising carriers (4) capturing the fish from the water in the well.

8. Device for handling fish falling off a fishing line comprising
a well (11) arranged to be filled with water wherein de-hooked fish are forced to fall,
means for creating a water flow in the well (11), and
a transport section (3,4) to bring fish out of the well (11).

9. Device according preceding claim 8, characterised in that flow-creating means comprise a nozzle-system (7) is arranged to inject water into the well or to recycle water in the well.

10. Device according to claim 8
characterised in a pipe system (50) is operable to supply water (sea water) to the pump/nozzle system.

11. Device according to claim 8 characterised in that the flow-creating means comprises a pipe system (14, 15, 16) including a thruster (15), to lead surplus water from the well back to the ocean, comprising a pump.

12. Device according to claim 8 characterised in that the flow-creating means comprise a given number of propellers (15) inside a discharge pipe from the well, or the well forming sections of the vessel.

13. Device according to claim 8 characterized in that the endless/interminable conveyor belt (13) comprises carriers arranged for said catch of fish.
